(19) United States
(12) Patent Application Publication
(10) Pub. No.: US 2003/0059674 A1
(43) Pub. Date: Mar. 27, 2003

(54) Electrode having expanded surface area and inner chamber encapsulating a highly reactive material for use in a liquid electrolyte battery

(76) Inventors: Gamdur Singh Mann, Grand Blanc, MI (US); Carl Elmer Miller, Millington, MI (US)

Correspondence Address: MARGARET A. DOBROWITSKY, DELPHI TECHNOLOGIES, INC., Legal Staff, Mail Code: 480-414-420, P.O. Box 5052, Troy, MI, 48007-5052, US

(21) Appl. No.: 09/964,905

(22) Filed: Sep. 27, 2001

(51) Int. Cl. H01M 4/02; H01M 4/70; H01M 4/38; H01M 10/06

(52) U.S. Cl. 429/128; 429/225; 429/240; 429/244; 429/241; 429/226

(57) ABSTRACT

An encapsulated electrode assembly which retains a highly reactive material to enhance reaction efficiency within a liquid electrolyte battery cell. The electrode assembly comprises a structural member of a first active material formed into a chamber within which is retained a highly reactive non-structural second active material that preferably comprises a particulated form of reactive material which provides increased electrochemical reaction per unit area in relation to the first reactive material. By way of example, when the invention is practiced within a lead-acid battery, the electrode pouch preferably comprises a reactive structural lead alloy, and the highly reactive material comprises lead containing compounds that support charge generation within the battery. The encapsulated electrode may additionally incorporate grids within, and in contact with, the chamber to further reduce current density within the electrode.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

The invention pertains generally to electrodes in liquid electrolyte batteries, and more particularly to an electrode having an inner chamber which encapsulates a highly reactive material.

2. Description of the Background Art

Batteries are utilized in a variety of electrical applications, such as for electrical storage within an automobile, or for powering an electric vehicle. These batteries are typically constructed as electrode plate pairs surrounded by a liquid electrolyte. Typically, the electrolyte is retained between the plates by a porous insulating material (separator) sandwiched between the plates that retains the plates in separation while not significantly restricting electrolyte movement.

A common form of liquid electrolyte battery is the lead-acid battery typified within automotive applications. The electrical power contained within a lead-acid battery is stored chemically and a lead-acid battery is considered a “secondary” battery because of its ability to be electrically recharged. The electrode plates within a standard lead-acid battery cell are commonly formed as reinforced sheets of a particulated non-structural form of highly reactive material. The electrode plates generally comprise lead alloy grids covered with a hardened paste material that contains lead oxides. The electrode plates are positioned within a housing that contains an electrolyte solution. Within batteries utilizing a lead-acid chemistry, the electrolyte contains a solution of sulfuric acid (H₂SO₄+H₂O).

The electrical energy within a lead-acid battery is stored in response to passing a charging current between a pair of positive and negative plates through the electrolyte so that the positive active mass (PAM) changes to dioxide of lead (PbO₂) and the negative active mass (NAM) changes to high surface area lead (Pb). This is called “sponge lead”. The electrical energy is thus stored in the battery in the chemical form as an oxide and sponge lead. During battery discharge, the dioxide of lead is converted to lead sulfate. Subsequent recharging restores the lead sulfate back to dioxide of lead and the cyclical charge and discharge cycles may continue until the structure has degraded to the point to where the battery is no longer capable of holding a charge.

These reactions occur at both the negative and positive plate for both charging and discharging and are described by the following chemical equations. Discharge at the negative plate is generally characterized by:

Pb+HSO₄⁻→PbSO₄+H⁺+2e

The charge reaction at the negative plate follows the converse of the above reaction. The associated reaction at the positive plate is given by:

PbO₂+3H⁺+HSO₄⁻+2e⁻→2PbSO₄+2H₂O

Charging at the positive plate is given by the converse of the above reaction. The overall combined reaction during discharge, therefore, is given by:

Pb+PbO₂+2H₂SO₄→2PbSO₄+2H₂O

It will be appreciated, therefore, that the energy of the battery is thus stored in a chemical form as an oxide. Increased levels of chemical storage during charging cause the equilibrium voltage of the battery to rise. When a load is applied across the terminals of the battery the process reverses. As current flows in the opposite direction, PbO₂ and sponge lead are converted to lead sulfate (PbSO₄). It will be appreciated that reaction site availability and charge collection efficiency within the battery largely determine the charging and discharging characteristics exhibited by the battery.

FIG. 1 through FIG. 4 illustrate conventional electrode construction for a positive electrode 10 and a negative electrode 20 having an active material retained on a grid structure 12. FIG. 1 is a front elevation view of a conventionally pasted surface electrode assembly 10 having a grid 12 which provides structural support and conduction to a connection tab 14. The grid structure 12 is retained within the hardened active material 16 to provide reinforcement and a collector surface having a low resistive connection with connection tab 14. The illustrations of FIG. 2 and FIG. 3 depict slight differentiation between the construction of a positive electrode of FIG. 2 and a negative electrode of FIG. 3. FIG. 2 illustrates the surface nature of the active material 16 applied to structural grid 12 for a positive electrode 10. Visible in the illustration are slight protrusions 18 of grid 12 that increase structural thickness of the electrode while providing a low resistance conduction path for the adhered active material. FIG. 13 illustrates a cross section of a similarly constructed conventional negative electrode assembly 20 having grid 12 which retains a negative active material (NAM) 22, preferably in the form of a cured paste that is adapted for use on the negative electrode. The composition of the cured paste 22 for the negative electrode preferably comprises the materials of the positive electrode in addition to an expanding agent. Use of an expanding agent in the negative electrode is preferred as it causes the paste material to expand into an open-cell formation providing increased reactive surface area. In addition, the negative electrode 20 is preferably configured with a perforated paper material 24 on each side to facilitate handling. FIG. 4 depicts grid 12 with connection tab 14 shown prior to pasting with active material, PAM 16, or NAM 22. Preferably grid 12 comprises an active electrode material, such as lead alloy. The positive and negative electrode plates are maintained in separation within the battery by a porous, or micro-porous separator (not shown) that allows substantially unrestricted movement of charges and ions.

Liquid electrolyte batteries utilizing conventionally pasted electrode plates provide a proven storage medium, but suffer from significant drawbacks with regard to efficiency, charge capacity, and capacity degradation. For example, the highly reactive material 16, 22, of the hardened paste interfaces with the electrolyte and is subject to substantial deterioration as a result of cycling. The hardened active material paste also exhibits a far lower conductance than that of the lead alloy material of the grid 12 to which it is attached and from which charge current is collected. Grid 12 collects current from each reaction site within the active material through the accompanying thickness of active material between the reaction site and the lead alloy of grid 12. It will be appreciated, therefore, that the resistance to current flow increases readily as the conduction distance through the active material increases. Furthermore, the active material paste is subject to breaking down and softening wherein portions of it may separate from the electrode and collect at the bottom of the battery, thereby leading to premature cell shorting.

Therefore, a need exists for an electrode that is capable of providing enhanced battery performance and longevity. The present invention satisfies those needs as well as others, and overcomes deficiencies of previously developed solutions.

### BRIEF SUMMARY OF THE INVENTION

The present invention is an electrode for a liquid electrolyte battery that provides increased levels of performance and cycle life. Electrodes according to the present invention encapsulate conventional active materials, such as highly reactive electrode paste, within an inner chamber or “pouch”. The present invention may additionally incorporate one or more grids retained within the chamber to further reduce collector current density. The invention is preferably used in batteries having a lead-acid chemistry, although the teachings of the present invention may be applied to liquid electrolyte batteries utilizing alternative chemistries.

By way of example, and not of limitation, an electrode according to the present invention generally comprises a pair of spaced-apart opposing lead or lead alloy plates as the primary structural components. The plates have fully or partially sealed edges that define an inner chamber configured for retention (i.e., encapsulation) of an active material containing lead oxide as a non-structural component. The opposing plates, which function as chamber walls, preferably include a plurality of apertures, such as perforations, for exposure of the liquid electrolyte to the interior active material. By employing solid lead or lead alloy surfaces, the large charge capacities provided by the use of conventional active material pastes can be achieved while, at the same time, high-rate capability and battery cycle life when exposed to discharge cycling can be improved. The surfaces on the opposing walls of the electrode provide a large current collector area to the electrolyte to which they are exposed, while the inclusion of an active material within the electrode significantly increases the reactive surface area which provides a concomitant increase in battery capacity.

In the present invention, collector resistance is reduced by increasing the amount of collector surface while the conduction distance through the active material paste is reduced. The lead or lead alloy exterior surfaces of the electrode are not subject to the rapid charge retention deterioration exhibited by the active material in response to battery cycling. Degradation in performance exhibited by the active material may thereby be offset by incorporation within an encapsulating electrode. Furthermore, the pouch configuration of the electrode serves to retain any active material fragments that may separate from hardened active material paste, thereby preventing material accumulation at the bottom of the cell which can lead to electrical shorts within the cell.

Placement of various non-structural highly reactive materials, such as electrode paste, within the electrode can provide a higher reaction rate per unit area than the use of structural type material of similar composition. The non-structural highly reactive material may comprise various chemically reactive materials in a form that provide a high surface area to volume ratio, such as oxides, particulated forms of material, or material applied to miniature structures such as small spheres of styrofoam or glass. Therefore, the overall capacity of a battery cell may be increased by the encapsulation of the highly reactive material within the electrode. Furthermore the active material does not require cycling prior to battery use for achieving satisfactory performance levels. The increased reaction rate of these highly reactive materials is typically the result of the materials that comprise particulates which offer increased surface areas and may provide open lattice structures for increased electrolyte migration.

The embodiments of the present invention described herein exemplify a lead or lead alloy electrode structure having an internal chamber for retaining an active material such as a hardened electrode paste. The active material is attached to and retained by the inside surfaces of the electrode walls or otherwise retained within the chamber. In a first embodiment, the apertures in the electrode walls comprise bent tabs, while in a second embodiment the apertures do not have tabs. Either embodiment can be practiced with or without an inner grid to increase surface contact area.

It will be appreciated that in all embodiments, a greater reactive surface area is provided for the active material than found in conventional electrodes because each electrode of the present invention has four surfaces rather than two; that is, each electrode has two outer surfaces and two inner surfaces. In addition, the structural lead or lead alloy which comprises the electrode offers a reactive surface to the liquid electrolyte which exhibits a low current density and whose charge retention does not deteriorate readily as a result of battery cycling. The electrode of the present invention provides increased current collector area, improved electrochemical conversion that enhances battery performance, and a reduction in the accumulation of conductive materials in the lower extremities of the cell which can lead to premature cell shorting.

An object of the invention is to increase the ability of a battery to withstand deep discharge cycling.

Another object of the invention is to increase maximum discharge rate and efficiency.

Another object of the invention is to increase battery performance.

Another object of the invention is to lower the material and processing costs associated with the manufacture of liquid electrolytic batteries.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a front elevation view of a conventional externally pasted positive electrode plate.

FIG. 2 is a cross-sectional view of the positive electrode of FIG. 1 taken through line 2-2.

FIG. 3 is a cross-sectional view of a conventional negative electrode plate.

FIG. 4 is a front elevation view of the lead or lead alloy grid contained within the conventional electrodes of FIG. 2 and FIG. 3.

FIG. 5 is a front elevation view of an electrode according to an embodiment of the present invention shown with a plurality of bent triangular-tabbed perforations.

FIG. 6 is a cross-section view of the electrode of FIG. 5 taken through line 6-6.

FIG. 7 is a detailed cross-section view of a portion of the electrode of FIG. 6 showing the inwardly bent pointed tabs in profile.

FIG. 8 is a detailed plan view of a triangular tab as shown in FIG. 5.

FIG. 9 is a cross-sectional view of an alternative embodiment of an electrode according to the present invention with a single center grid.

FIG. 10 is a detailed cross-section view of a portion of the electrode of FIG. 9.

FIG. 11 is a front elevation view of an alternative embodiment of an electrode according to the present invention shown configured with stamped non-tabbed perforations.

FIG. 12 is a cross-section view of the electrode of FIG. 11 taken through line 12-12.

FIG. 13 is a flowchart of an embodiment of a process for fabricating an electrode according to the present invention.

FIG. 14 is a graph of discharge voltage over time for a conventional two plate battery cell.

FIG. 15 is a graph of discharge voltage over time for a battery having an electrode according to the present invention.

FIG. 16 is a graph of battery cell discharge capacity, at a constant current drain of two amperes from a conventional battery in comparison with a battery having an electrode according to the present invention.

FIG. 17 is a graph of remaining battery cell discharge capacity, at a drain of fifty amperes, from a conventional battery in comparison with a battery having an electrode according to the present invention.

FIG. 18 is a graph of remaining cell capacity for a conventional battery in comparison with a battery having an electrode according to the present invention shown as a function of the number of discharge cycles to which the battery has been subjected.

FIG. 19 is a graph of battery capacity after cycling for a conventional battery in comparison with a battery utilizing an electrode according to the present invention.

FIG. 20 is a graph of battery capacity loss for a conventional battery in comparison with a battery utilizing an electrode according to the present invention.

### DETAILED DESCRIPTION OF THE INVENTION

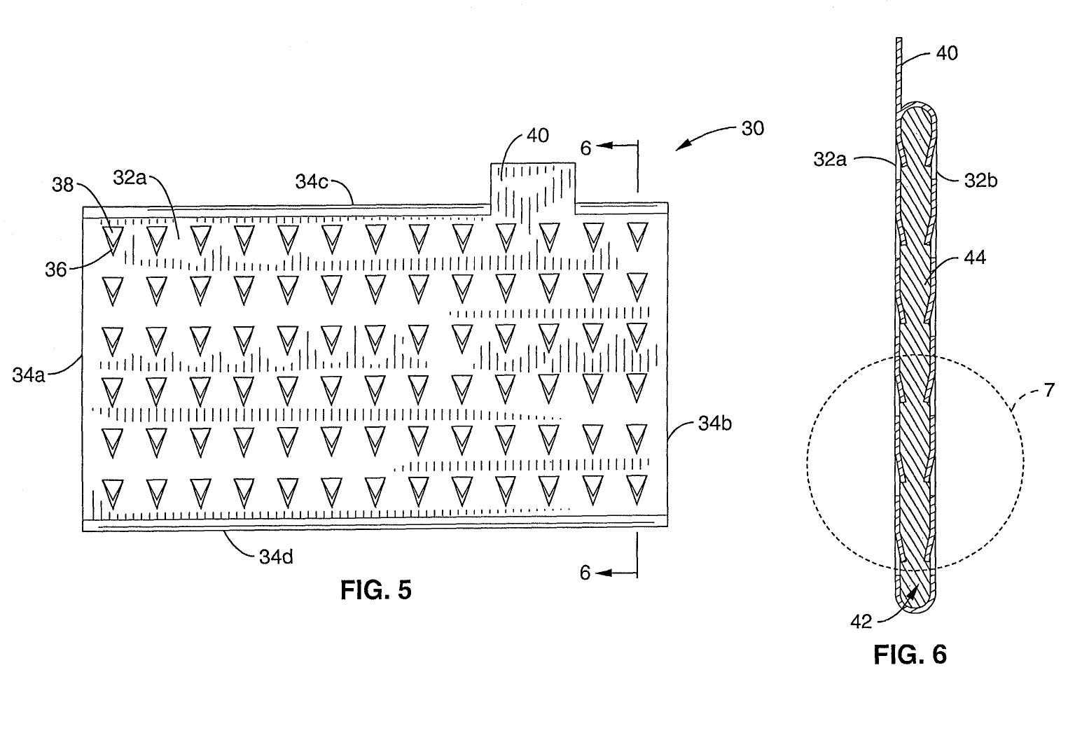

Referring more specifically to the drawings, for illustrative purposes the present invention is embodied in the apparatus and method generally shown in FIG. 5 through FIG. 20. It will be appreciated that the apparatus may vary as to configuration and as to details of the parts, and that the method may vary as to the specific steps and sequence, without departing from the basic concepts as disclosed herein.

Referring first to FIG. 5, an embodiment of an electrode 30 according to the present invention is shown. In this embodiment, electrode 30 comprises a sheet of lead or lead alloy that is bent, molded or the like into a configuration forming spaced-apart opposing plates 32a, 32b which are partially or fully sealed at edges 34a, 34b, 34c, 34d. A plurality of apertures 36 are cut, stamped or the like such that they extend through plates 32a, 32b. Apertures 36 are illustrated in the form of bent tabs 38 created in plates 32a, 32b. A connection tab 40 is preferably provided to facilitate connecting a plurality of electrodes 30 to one another in the desired electrical configuration, such as in series, within the battery assembly.

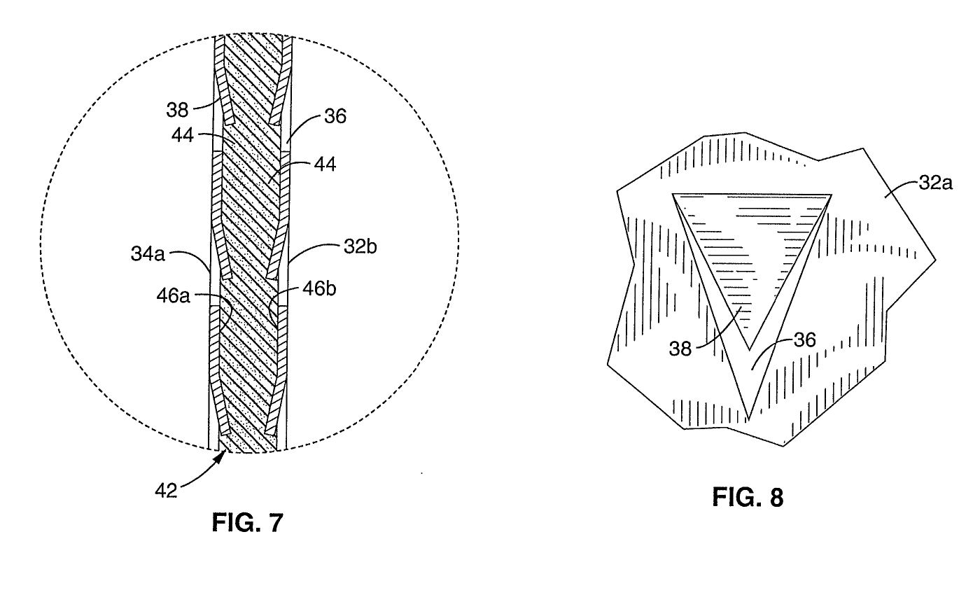

Referring now to FIG. 6 and FIG. 7, plates 32a, 32b define an inner chamber 42 in which an active material 44 can be placed. Preferably, active material 42 is in the form of a paste or the like that substantially coats one or both of the inner surfaces 46a, 46b of plates 32a, 32b, respectively, as shown in FIG. 6 and FIG. 7. Alternatively, active material 44 can be in the form of one or more layers of material held between the inner surfaces 46a, 46b, or in another form that permits the material to be encapsulated within chamber 42.

Referring also to FIG. 8, a plurality of apertures 36 are formed in one or both of plates 32a, 32b by creating V-shaped tabs 38 to allow liquid electrolyte in the battery to flow from the exterior of the electrode into the interior where the active material is encapsulated. Note, however, that even an electrode according to the present invention that has not been filled with an active material can increase current collector surface area in relation to a single perforated plate, because the outer and inner surfaces of both plates will be exposed to the electrolyte.

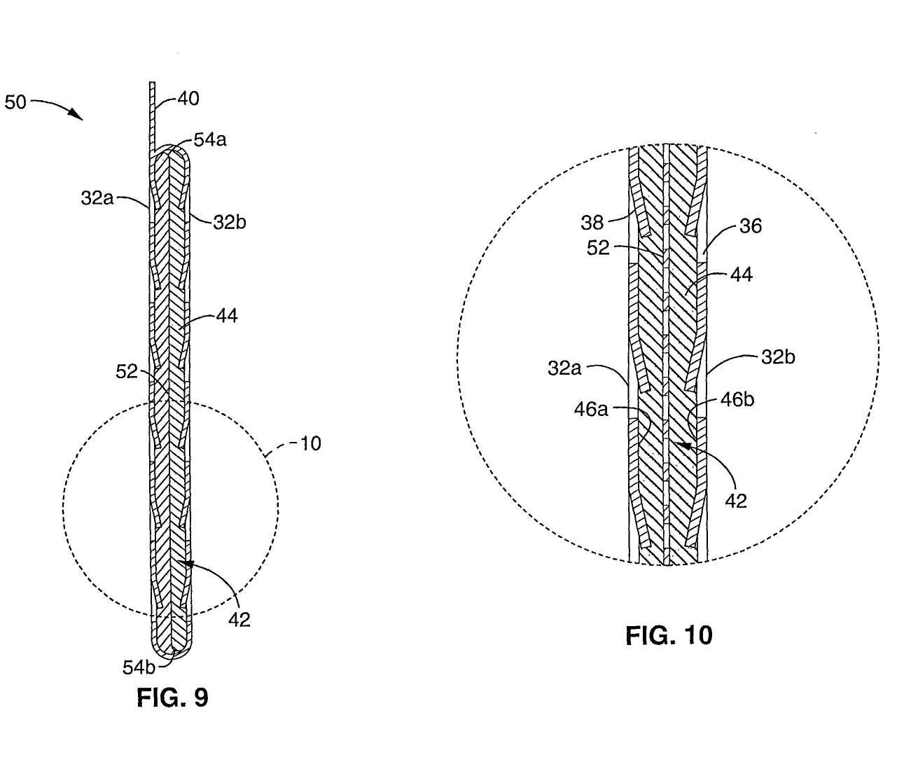

FIG. 9 and FIG. 10 illustrate an alternative electrode embodiment 50 that incorporates a center grid 52 of metallic electrode material which is attached to the interior of the pouch at an upper connection 54a and at a lower connection 54b. Center grid 52 provides additional contact area between the paste material and the metallic electrode to increase collector area and thereby further reduce the current density. It will be appreciated that more than one interior grid may be incorporated within the chamber of the electrode, preferably embedded within the active material, to enhance charge collection.

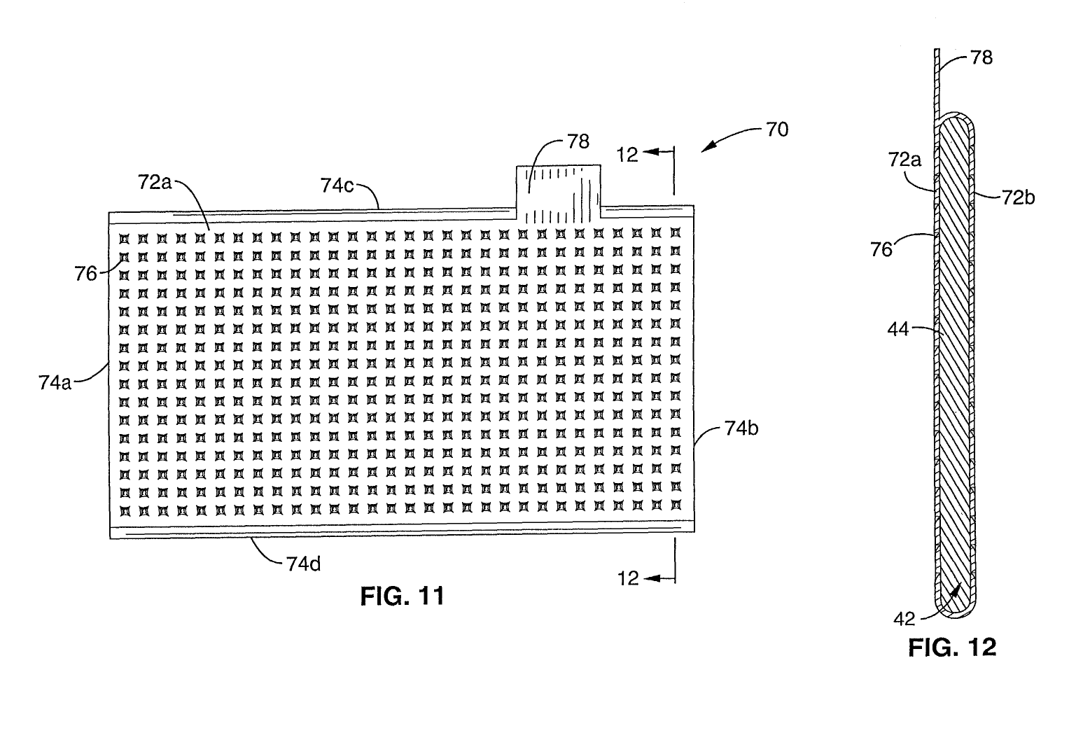

FIG. 11 and FIG. 12 illustrate a further alternative electrode embodiment 70 having spaced-apart opposing plates 72a, 72b and edges 74a, 74b, 74c, 74d, which partially or fully seal the two plates as before. Instead of the V-shaped tabs and apertures in the plates as previously described, however, this embodiment includes a plurality of small perforations 76 in one or both plates. It will be appreciated from the foregoing discussion that the use of small perforations will increase the amount of current collector area available. Perforations 76 may be created by a number of alternative means, such as by utilizing a perforation roller, by a stamping process, by cutting perforations, or by other perforating methods. It will be appreciated that cutting may be performed utilizing conventional processes, such as die-cutting, milling, drilling, and laser cutting. The interconnection of a series of electrodes is facilitated by a connection tab 78 which projects from the electrode pouch. FIG. 12 depicts the interior of electrode 70 with perforations 76 which facilitate electric charge and ion migration between the electrolyte and active material 44. In view of the preceding embodiments, it should be appreciated that the apertures 76 within the encapsulated electrode plate may be created in a number of alternative configurations utilizing various methods.

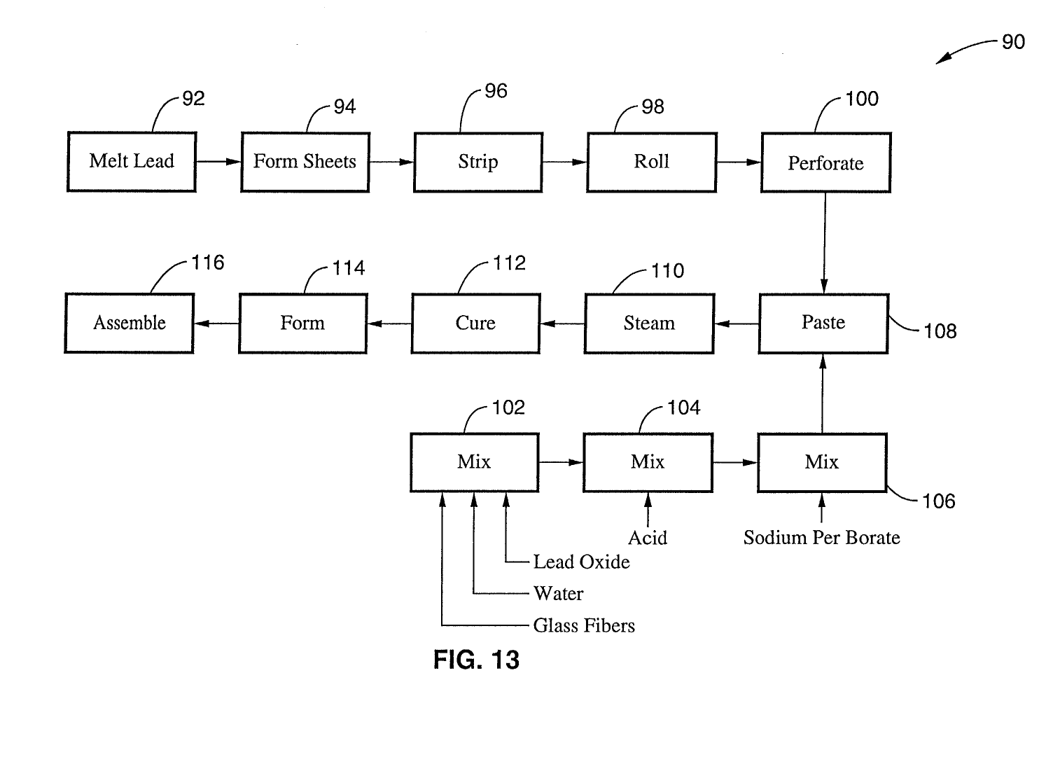

Referring now to FIG. 13, a preferred process flow 90 for fabricating an embodiment of the an electrode assembly according to the invention is shown. The structural material that will make up the pouch is preferably fabricated first. At block 92, a lead alloy which preferably comprises approximately 1.5% tin (Sn) and approximately 0.08% cadmium (Cd) is melted. At block 94, sheets of the lead alloy having a thickness of approximately 0.010 inches thick are then manufactured. A machine such as a drum caster may be utilized to manufacture the lead alloy sheets. At block 96, using a rolling mill or the like, each lead sheet is then separated into strips which are subsequently worked into preferably thinner strips at block 98, preferably approximately 0.005 inch thick. Alternatively, molten lead may be cast into ingots which then are rolled to form strips. The material is then perforated at block 100, preferably using a perforation roller or the like to create a minimum of about 5% open area, while the creation of a structure with over 10% open area is preferred. It will be recognized by one of ordinary skill in the art that the casting, stripping, rolling, and perforating steps may be performed on a variety of equipment with numerous alternative methods to yield similar results.

The active material that will be retained in the pouch is then created starting at block 102. Preferably the active material is formulated as an electrode paste capable of being cured to a solid form after application to the lead alloy material, and generally comprises sulfates, hydroxides, free lead, carbonates, and a binding agent. The complex paste is preferably converted to sulfates by the addition of a sufficient quantity of acid, in a process referred to as pickling that takes place after the paste is applied to the interior surfaces of the plates and cured. The “pickled” pouches are “formed” (charged for the first time) by passing a sufficient current through the pouch for a given period of time.

By way of example, at block 102 an active material is mixed from lead oxide to which a sufficient quantity of water is added to form a paste. Binding agents, preferably glass fibers, may be added to increase the cohesion of the active material. Acid is added and mixed at block 104, and sodium per borate is then added and mixed at block 106 to produce a paste having approximately 12% sulfate (SO₄). The aforesaid process creates a paste which may be adhered to one or both interior surfaces of the lead alloy material, such as by a pasting or screening process as shown at block 108, and thereby be retained. The pasted lead alloy material is then folded over to create the walls of the electrode.

The pasted lead alloy material is then steamed at block 110 and cured at block 112, whereupon the folded halves of the pouch are joined together, such as by soldering the perimeters on the two halves of the folded lead alloy sheet. It will be appreciated that a pouch or encapsulated electrode may be created by any of various other methods without departing from the teachings of the present invention. The electrode with encapsulated active material is thereafter “formed” at block 114, wherein “forming” comprises the process of charging the cell for the first time. Subsequent to forming, the cell may be assembled into its final configuration within a battery at block 116.

The above description exemplifies a process for fabricating an encapsulated electrode assembly 30 according to an aspect of the present invention having active material 42 adjoined to perforated inner surfaces of a pouch prior to those surfaces being folded and assembled into an electrode. Pouch 31 was fabricated from lead, or lead alloy, to provide a collector formed of active material. The incorporation of active material, preferably highly reactive material, within the perforated pouch provides additional reactive surface whose generated charges are readily collected by the multiple solid lead alloy collection surfaces provided within the present invention.

It will be appreciated, however, that the fabrication process described can be applied to all of the embodiments described herein and variations thereof. It will also be appreciated that perforation of the plates may be performed at any time in the electrode fabrication process, such as after the adjoining of active material to the surface. Also, various forms of active material that support the electrochemical reaction of the battery may be retained within the chamber of the electrode pouch.

### EXAMPLE 1

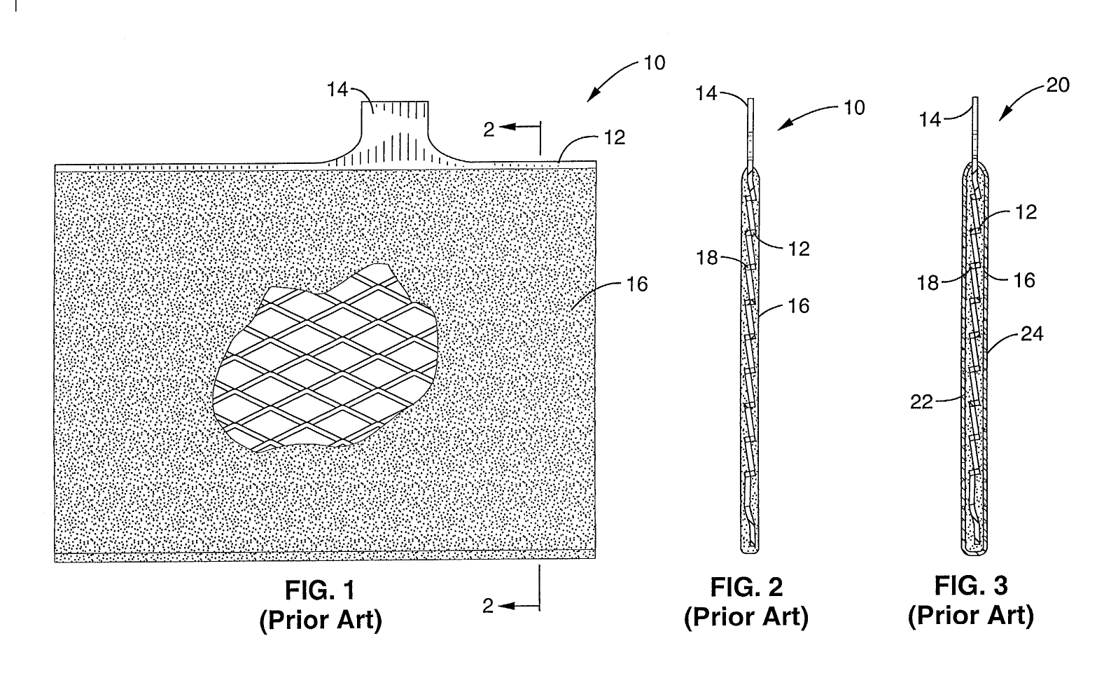

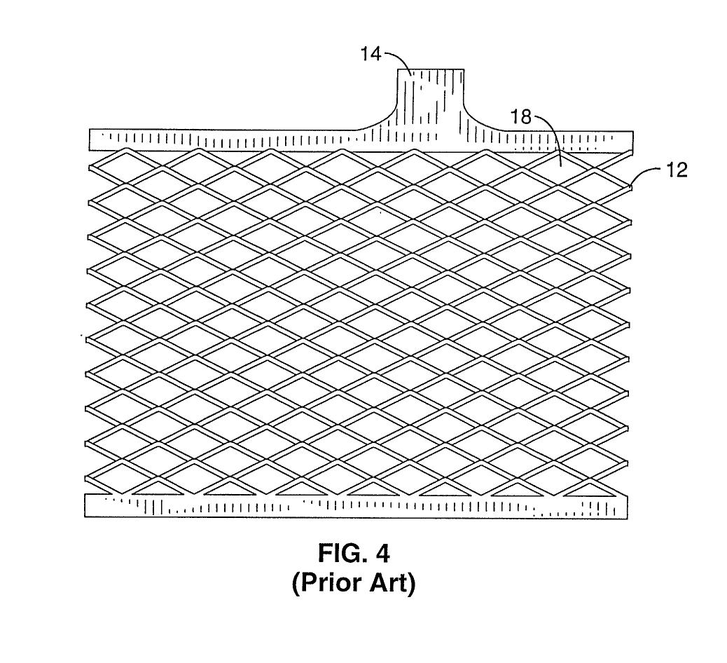

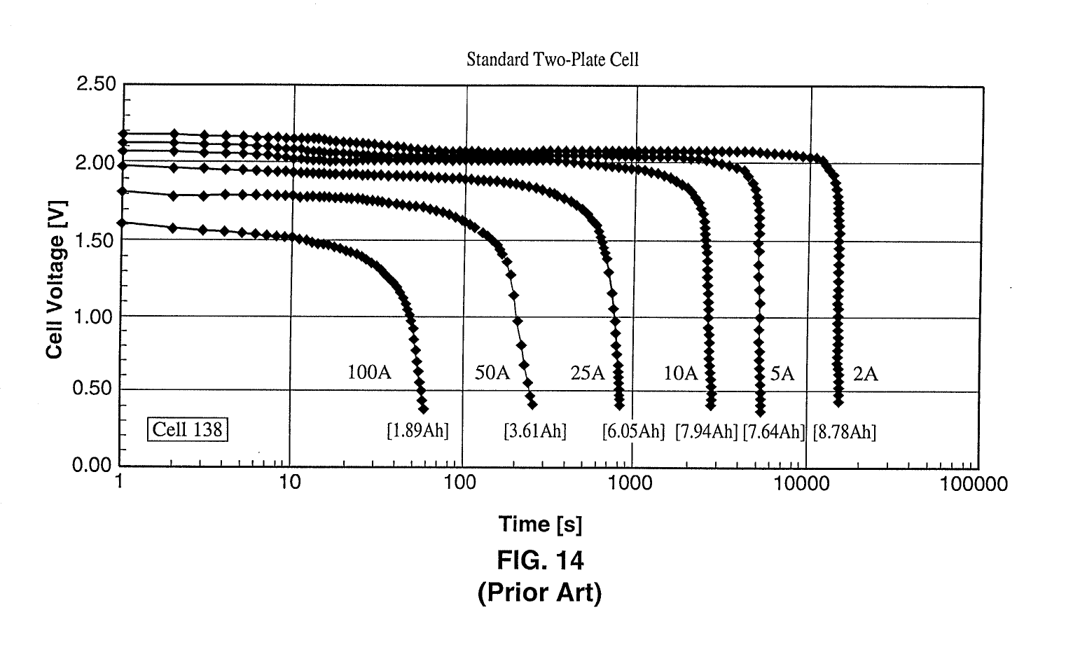

FIG. 14 illustrates discharge characteristics for a conventional battery electrode, an example of which was shown in FIG. 1, when subject to discharge at current level which corresponds to a variety of loads. The discharge curve shows battery voltage over time for a standard two plate cell at a series of discharge rates from 2 A to 100 A. The tests were conducted from a fully charged state, from which the cells were discharged until measured cell voltage dropped to approximately 0.4 V. The capacity test was performed at an ambient temperature that ranged from 75° F. to 85° F. Ampere-hour capacity for the associated cell was calculated based on the voltage profile with respect to time at the given discharge current level represented by each of the curves. The calculated ampere-hour figure is depicted in brackets below each depicted curve within the graph of FIG. 14.

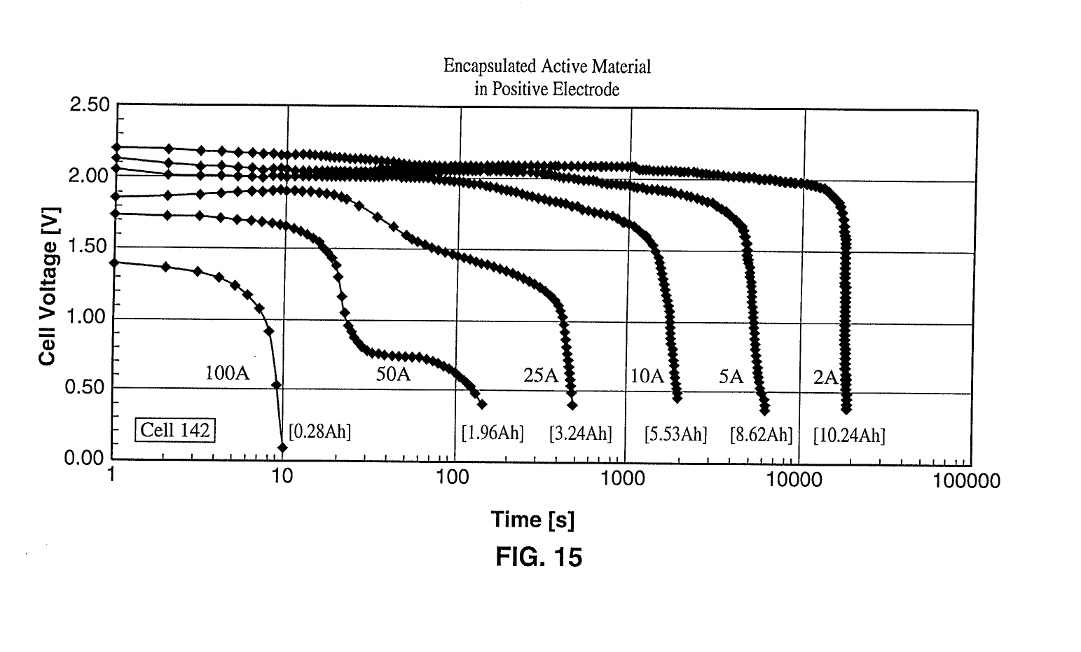

Referring now to FIG. 15, battery capacity is illustrated for a test cell according to the present invention in which a pouch electrode providing approximately 8% open area within the perforations, and containing encapsulated active material, such as shown in FIG. 11, was utilized in the battery cell in combination with a conventional negative electrode. It will be appreciated that the 10.24 Ah capacity of the cell employing the electrode pouch with encapsulated active material of the present invention exceeds that of a standard cell whose capacity was 8.78 Ah under the specified low-rate discharge conditions. It was determined as a result of this comparison test that battery cells fabricated according to the present invention exhibit characteristics favorable in a number of applications.

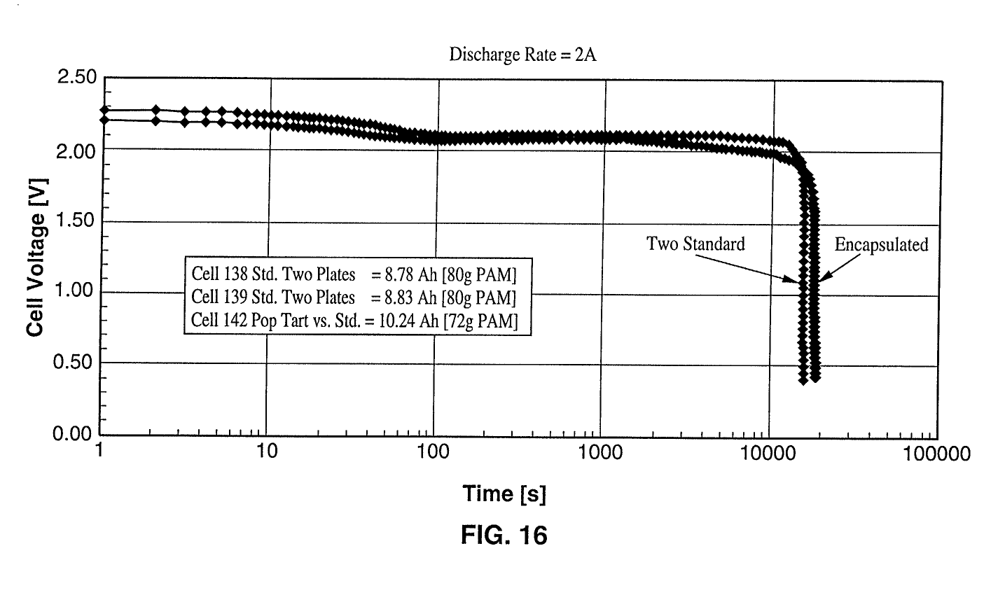

FIG. 16 provides a graphical comparison of low-rate discharge characteristics between a pair of conventional battery types and a test battery utilizing the encapsulated electrode and providing approximately 8% open area within the perforations. The increased capacity of the test battery is reflected as increased discharge time. According to the test results, the battery of the present invention is capable of supplying operating current for a period of time which exceeds that of a conventional battery. Although the discharge times for the electrode types appear closely similar within the graph, it should be recognized that a logarithmic scale was employed for the horizontal time axis. The encapsulated electrode battery exhibited a significant capacity improvement of approximately 16% in relation to a conventional battery. The test battery cell was able to generate current for 10.2 hours, while the standard battery cells provided current for an average of 8.8 hours. It will be appreciated that additional capacity improvements are anticipated within the present invention as the fabrication process is refined beyond that utilized to create the test cell.

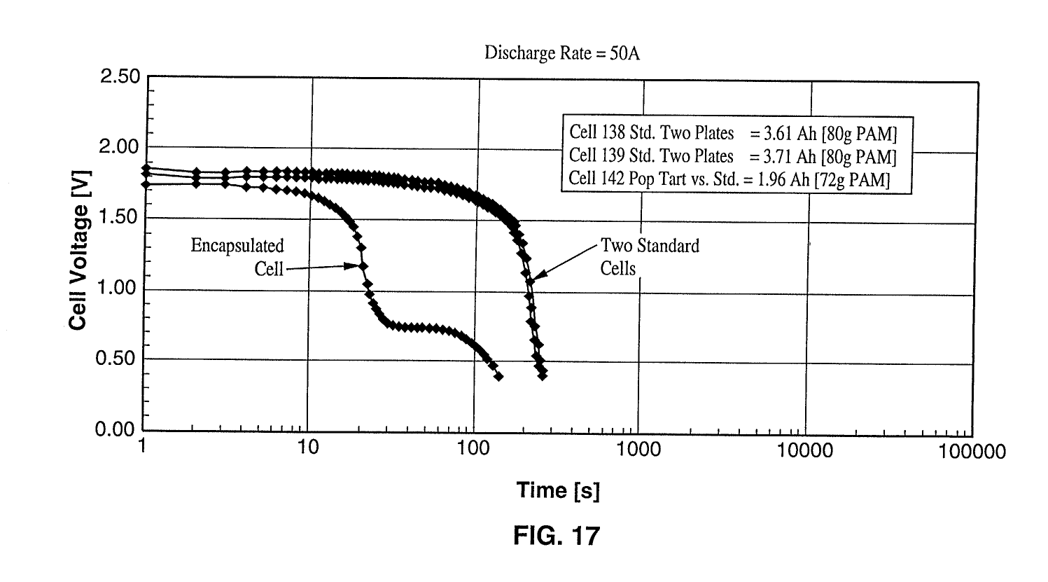

FIG. 17 illustrates comparative cell discharge profiles at a discharge level of 50 A for a pair of standard cells and a cell utilizing the encapsulated active material electrode having approximately 8% perforated open area.

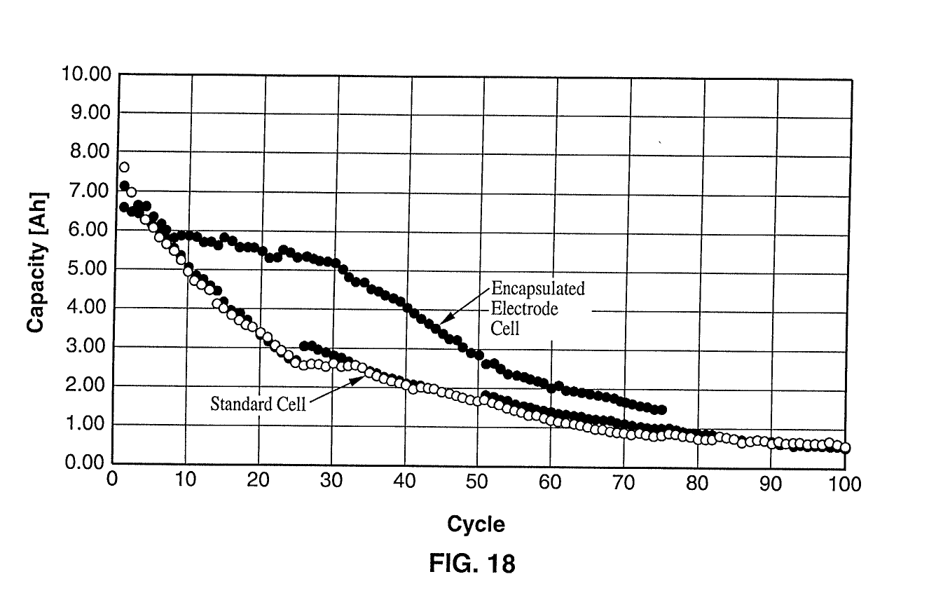

FIG. 18 compares battery cycling characteristics wherein cycle to cycle capacity loss was plotted for a pair of standard cells in comparison with a cell utilizing the encapsulated active material electrode with approximately 8% perforated open area. It will be appreciated from the graph that the cell incorporating the encapsulated active material generally shows a greater capacity retention per deep discharge cycle than the standard battery cell.

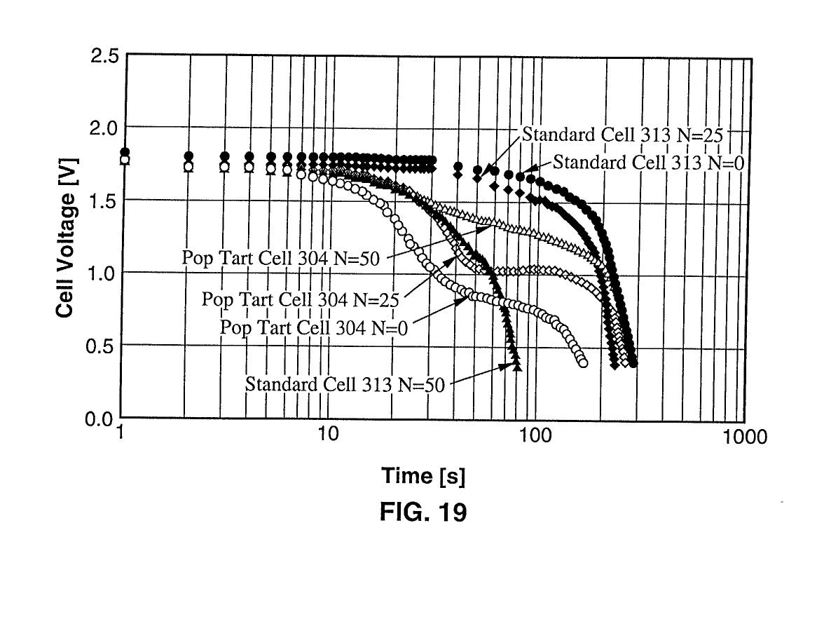

FIG. 19 provides a performance comparison between the use of a conventional positive electrode and an encapsulated active material electrode assembly, such as depicted in FIG. 11, which provides an increased perforation area of 15% and is referred to in the graph as a “pop-tart” cell. A conventional negative electrode was utilized for both sets of curves. A series of voltage curves show battery discharge characteristics as a function of the number of battery cycles performed. The encapsulated electrode being tested comprised an interior surface upon which was retained approximately 4 lbs. of hand applied active material paste that contained SO₄ at a concentration of approximately 12%. The comparison test was performed at a high current discharge rate of fifty amperes at a room temperature of 80° F. It will be readily appreciated that the “pop-tart” cell construction of the present invention provides increased discharge performance as the number of discharge cycles increases from zero through at least fifty discharges. By contrast, the performance of a conventional cell drops off readily beyond approximately twenty five discharge cycles.

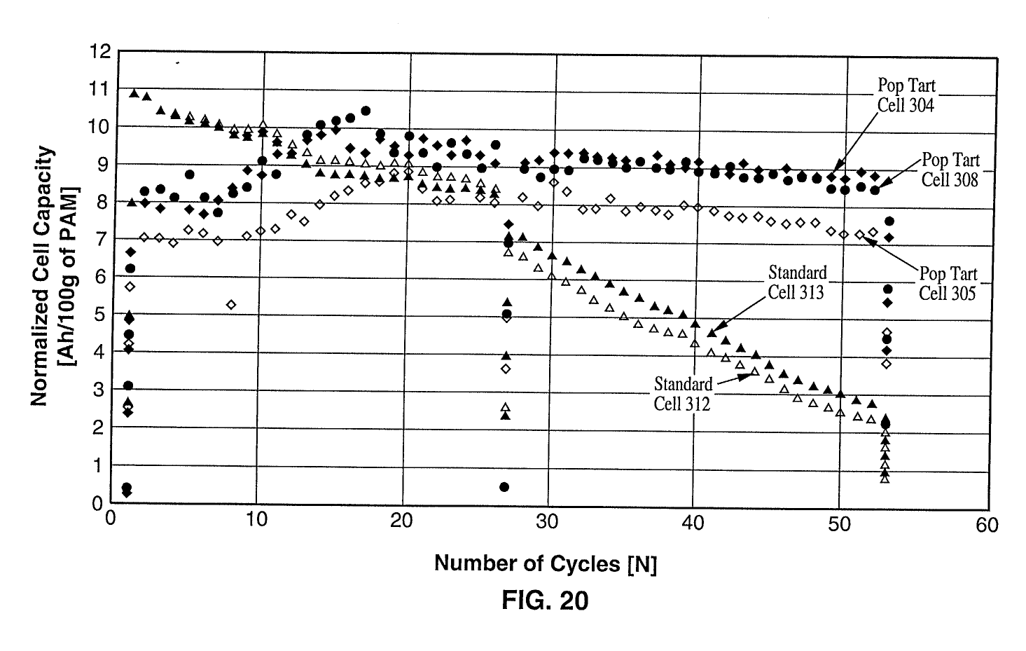

FIG. 20 illustrates battery cell capacity loss after fifty cycles for three encapsulated “pop-tart” active material electrodes in comparison with two conventional electrodes under a 5 A current discharge at an ambient temperature of 80° F. The vertical measurement “bars” within the plot of cycles correspond to additional tests performed at the beginning, middle, and end of cycle testing. It will be appreciated, therefore, that the total number of cycles is equal to fifty as given by the last test, shown at cycle fifty three, less the three tests shown. The testing was performed utilizing encapsulated active material electrodes for both the positive and negative electrodes within the cell. The positive electrode plate was pasted with a paste material comprising 12% SO₄ positive active material (PAM), while the negative plate was pasted with a 10% SO₄ negative active material (NAM). The capacity comparison is normalized to the weight of PAM given as ampere hour units per one hundred grams of PAM (Ah/100 g). After fifty cycles, the three cells according to the invention provided normalized capacities of 9.02 Ah/100 g, 7.74 Ah/100 g, and 8.99 Ah/100 g, yielding a combined normalized average of 8.58 Ah/100 g. In contrast, the cells with conventional electrodes provided normalized capacities of 6.83 Ah/100 g and 6.97 Ah/100 g, yielding a combined normalized average of 6.90 Ah/100 g of PAM. It will be appreciated that the encapsulated active material electrodes according to the present invention provided a 24.4% increase in cell capacity in relation to the given PAM weight.

The aforementioned tests indicate that the use of PAM and NAM electrodes as taught by the present invention can be utilized to improve battery performance characteristics in a number of significant ways. Capacity retention in response to deep discharge cycling shows a marked increase approaching an approximately 25% capacity improvement after fifty cycles. Material utilization was increased from 28% in a conventional cell to 35% in the test cell according to the invention. It will be appreciated further that the performance of a conventional cell deteriorated rapidly under cycling, while a cell fabricated according to the present invention provided steadily improving capacity as it was cycled through the first fifty cycles.

Accordingly, it will be seen that this invention provides an electrode and a fabrication method thereof, that provides enhanced battery performance. Electrodes according to the invention comprise the incorporation of multiple collection surfaces within an encapsulated active material electrode. It will be appreciated that the electrode plates and methods described may be implemented with numerous variations obvious to one of ordinary skill in the art. The active material may be retained by an encapsulating structural member that may be variously configured to provide support while retaining the active material. It should be appreciated, therefore, that the specific construction details of the embodiments are provided by way of example. The perforations within the encapsulating pouch were exemplified as both V-shaped inwardly bent tabs and punched apertures. It will be appreciated, however, that apertures may be created in a wide range of shapes by numerous methods, and that the structural member upon which the active material paste is applied may be configured in a number of alternative configurations which will support and retain the active material. It will be further appreciated that the paste material described for the present invention may be created with additional elements, a variation of process steps, and in various forms for retention within the electrode.

Although the description above contains many specificities, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An electrode for use in a battery, comprising:
at least two spaced-apart opposing plates comprising a material reactive to an electrolyte;
an inner chamber defined by said plates; and
at least one aperture extending through at least one of said plates.

2. An electrode as recited in claim 1, wherein said inner chamber is configured to retain a second material reactive to said electrolyte.

3. An electrode as recited in claim 2, wherein said apertures are configured to allow charge and ion migration between said electrolyte and said second reactive material.

4. An electrode as recited in claim 1, wherein said plates are joined at peripheral edges.

5. An electrode as recited in claim 4, wherein said joined peripheral edges provide a peripheral seal between said plates for retention of a second reactive material.

6. An electrode as recited in claim 1, wherein said apertures are defined by bent tabs.

7. An electrode as recited in claim 1, wherein said apertures are defined by perforations.

8. An electrode as recited in claim 1, wherein said apertures provide at least approximately five percent open area in said plates.

9. An electrode as recited in claim 1, further comprising at least one perforated grid member within said chamber.

10. An electrode as recited in claim 1, wherein said reactive material comprises lead.

11. An electrode as recited in claim 1, wherein said reactive material comprises a lead alloy.

12. An electrode as recited in claim 1, wherein said reactive material comprises a lead alloy for use in a liquid electrolyte battery having a lead-acid chemistry.

13. An electrode as recited in claim 1, wherein said reactive material comprises a lead material for use in a liquid electrolyte battery having a lead-acid chemistry.

14. An electrode as recited in claim 1, further comprising a second material (44) reactive to said electrolyte retained within said inner chamber.

15. An electrode as recited in claim 14, wherein said second reactive material comprises a lead-based compound.

16. An electrode as recited in claim 14, wherein said second reactive material comprises a lead-based compound for use within a lead-acid liquid electrolyte battery.

17. An electrode as recited in claim 14, wherein said second reactive material comprises a material in a particulated, non-structural, form which provides increased reactive surface per unit area in relation to the first reactive material.

18. An electrode as recited in claim 14, wherein said second reactive material comprises lead-based compounds for use within a lead-acid liquid electrolyte battery.

19. An electrode as recited in claim 14, wherein said second reactive material comprises a mixture of lead-oxide, glass fibers, and sodium per borate.

20. An electrode as recited in claim 14, wherein said second reactive material comprises a mixture of sulfates, hydroxides, free lead, carbonates, and a binding agent.

21. An electrode for use in a battery, comprising:
at least two spaced-apart opposing plates comprising a first material reactive to an electrolyte;
means for retaining a second material reactive to said electrolyte between said plates; and
at least one aperture extending through at least one of said plates.

22. An electrode as recited in claim 21, wherein said means comprises an inner chamber.

23. An electrode as recited in claim 21, wherein said apertures are configured to allow charge and ion migration between said electrolyte and said second reactive material.

24. An electrode as recited in claim 21, wherein said plates are joined at peripheral edges.

25. An electrode as recited in claim 24, wherein said joined peripheral edges provide a peripheral seal between said plates for retention of a second reactive material.

26. An electrode as recited in claim 21, wherein said apertures are defined by bent tabs.

27. An electrode as recited in claim 21, wherein said apertures are defined by perforations.

28. An electrode as recited in claim 21, wherein said apertures provide at least approximately five percent open area in said plates.

29. An electrode as recited in claim 22, further comprising at least one perforated grid member within said inner chamber.

30. An electrode as recited in claim 21, wherein said reactive material comprises lead.

31. An electrode as recited in claim 21, wherein said reactive material comprises a lead alloy.

32. An electrode as recited in claim 21, wherein said reactive material comprises a lead alloy for use in a liquid electrolyte battery having a lead-acid chemistry.

33. An electrode as recited in claim 21, wherein said reactive material comprises a lead material for use in a liquid electrolyte battery having a lead-acid chemistry.

34. An electrode as recited in claim 22, further comprising a second material reactive to said electrolyte retained within said inner chamber.

35. An electrode as recited in claim 34, wherein said second reactive material comprises a lead-based compound.

36. An electrode as recited in claim 34, wherein said second reactive material comprises a lead-based compound for use within a lead-acid liquid electrolyte battery.

37. An electrode as recited in claim 34, wherein said second reactive material comprises a material in a particulated, non-structural, form which provides increased reactive surface per unit area in relation to the first reactive material:

38. An electrode as recited in claim 34, wherein said second reactive material comprises lead-based compounds for use within a lead-acid liquid electrolyte battery.

39. An electrode as recited in claim 34, wherein said second reactive material comprises a mixture of lead-oxide, glass fibers, and sodium per borate.

40. An electrode as recited in claim 34, wherein said second reactive material comprises a mixture of sulfates, hydroxides, free lead, carbonates, and a binding agent.

41. An electrode for use in a battery, comprising:
at least two spaced-apart opposing plates comprising a first material reactive to an electrolyte;
an inner chamber defined by said plates;
at least one aperture extending through at least one of said plates; and
a second material reactive to said electrolyte retained in said inner chamber.

42. An electrode as recited in claim 41, wherein said apertures are configured to allow charge and ion migration between said electrolyte and said second reactive material.

43. An electrode as recited in claim 41, wherein said plates are joined at peripheral edges.

44. An electrode as recited in claim 43, wherein said joined peripheral edges provide a peripheral seal between said plates for retention of said second reactive material.

45. An electrode as recited in claim 41, wherein said apertures are defined by bent tabs.

46. An electrode as recited in claim 41, wherein said apertures are defined by perforations.

47. An electrode as recited in claim 41, wherein said apertures provide at least approximately five percent open area in said plates.

48. An electrode as recited in claim 41, further comprising at least one perforated grid member within said inner chamber.

49. An electrode as recited in claim 41 wherein said reactive material comprises lead.

50. An electrode as recited in claim 41, wherein said reactive material comprises a lead alloy.

51. An electrode as recited in claim 41, wherein said reactive material comprises a lead alloy for use in a liquid electrolyte battery having a lead-acid chemistry.

52. An electrode as recited in claim 41, wherein said reactive material comprises a lead material for use in a liquid electrolyte battery having a lead-acid chemistry.

53. An electrode as recited in claim 41, wherein said second reactive material comprises a lead-based compound.

54. An electrode as recited in claim 41, wherein said second reactive material comprises a lead-based compound for use within a lead-acid liquid electrolyte battery.

55. An electrode as recited in claim 41, wherein said second reactive material comprises a material in a particulated, non-structural, form which provides increased reactive surface per unit area in relation to the first reactive material.

56. An electrode as recited in claim 41, wherein said second reactive material comprises lead-based compounds for use within a lead-acid liquid electrolyte battery.

57. An electrode as recited in claim 41, wherein said second reactive material comprises a mixture of lead-oxide, glass fibers, and sodium per borate.

58. An electrode as recited in claim 41, wherein said second reactive material comprises a mixture of sulfates, hydroxides, free lead, carbonates, and a binding agent.

59. An electrode, comprising:
a plurality of spaced-apart substantially planar sections having peripherally joined edges (34a-34d, 74a-74d) defining an interior chamber;
said planar sections formed from an active material that chemically supports battery charge generation; and
a plurality of apertures through at least one of said planar sections.

60. An electrode as recited in claim 59, further comprising a second active material within said chamber, wherein said second active material is capable of providing a chemical reaction in support of battery charge generation.

61. An electrode as recited in claim 59, wherein said apertures are configured to allow charge and ion migration between said electrolyte and said second reactive material.

62. An electrode as recited in claim 59, wherein said apertures are defined by bent tabs.

63. An electrode as recited in claim 59, wherein said apertures are defined by perforations.

64. An electrode as recited in claim 59, wherein said apertures provide at least approximately five percent open area in said plates.

65. An electrode as recited in claim 59, further comprising at least one perforated grid member within said interior chamber.

66. An electrode as recited in claim 59 wherein said reactive material comprises lead.

67. An electrode as recited in claim 59, wherein said reactive material comprises a lead alloy.

68. An electrode as recited in claim 59, wherein said reactive material comprises a lead alloy for use in a liquid electrolyte battery having a lead-acid chemistry.

69. An electrode as recited in claim 59, wherein said reactive material comprises a lead material for use in a liquid electrolyte battery having a lead-acid chemistry.

70. An electrode as recited in claim 59, wherein said second reactive material comprises a lead-based compound.

71. An electrode as recited in claim 59, wherein said second reactive material comprises a lead-based compound for use within a lead-acid liquid electrolyte battery.

72. An electrode as recited in claim 59, wherein said second reactive material comprises a material in a particulated, non-structural, form which provides increased reactive surface per unit area in relation to the first reactive material.

73. An electrode as recited in claim 59, wherein said second reactive material comprises lead-based compounds for use within a lead-acid liquid electrolyte battery.

74. An electrode as recited in claim 59, wherein said second reactive material comprises a mixture of lead-oxide, glass fibers, and sodium per borate.

75. An electrode as recited in claim 59, wherein said second reactive material comprises a mixture of sulfates, hydroxides, free lead, carbonates, and a binding agent.

76. A method of increasing chemical reaction efficiency for an electrode assembly configured for use within a liquid electrolyte battery, comprising:
forming a chamber within a first active material; and
inserting a highly reactive second material within the chamber, wherein the highly reactive second material is capable of supporting charge generation within the liquid electrolyte battery.

77. A method as recited in claim 76, wherein the highly reactive second material comprises a non-structural material which provides a higher per-unit area reaction efficiency than that of the first active material.

78. A method as recited in claim 76, wherein the highly reactive second material comprises a reactive material configured in a particulated form which increases reactive surface area.

79. A method as recited in claim 76, wherein the highly reactive second material comprises lead-based compounds for use within a lead-acid liquid electrolyte battery.

79. A method as recited in claim 76, wherein said reactive material is created from mixing a composition comprising lead-oxide, glass fibers, and sodium per borate.

80. A method as recited in claim 76, wherein the reactive material is created from mixing a composition comprising a mixture of sulfates, hydroxides, free lead, carbonates, and a binding agent.
